(19) United States
(12) Patent Application Publication
(10) Pub. No.: US 2024/0020232 A1
(43) Pub. Date: Jan. 18, 2024

(54) METHODS AND APPARATUS FOR SELECTIVELY CACHING MAINFRAME DATA

(71) Applicant: GT Software D. B. A. Adaptigent, Atlanta, GA (US)

(72) Inventor: Alexander Montgomery Heublein, Canton, GA (US)

(73) Assignee: GT Software D.B.A Adaptigent, Atlanta, GA (US)

(21) Appl. No.: 17/812,617

(22) Filed: Jul. 14, 2022

(51) Int. Cl. G06F 12/0802

(52) U.S. Cl. CPC G06F 12/0802; G06F 2212/60

(57) ABSTRACT

Methods and apparatus for selectively caching mainframe data are disclosed. In one embodiment, the disclosed process receives user inputs via a graphical user interface (GUI) indicating that certain data types on a first mainframe computer are cacheable. Subsequently, when application programming interface (API) requests are received, data associated with cacheable data types are cached and data associate with noncacheable data types are preferably not cached. When additional API requests are received, cached data is retrieved from the cache and noncached data is retrieved from one or more mainframe computers.

The present disclosure relates in general to caching mainframe data, and, in particular, to methods and apparatus for selectively caching mainframe data based on user interface selections designating cacheable and noncacheable data types.

### BACKGROUND

Often, when one computing device requests data from another computing device, the response data may be cached in anticipation of another request for the same data. In this manner, the data may be delivered subsequent times at decreased latency and/or decreased cost. However, present caching methods fail to discriminate between cacheable and noncacheable data types.

### SUMMARY

Methods and apparatus for selectivity caching mainframe data types are disclosed. More specifically, a graphical user interface is used to manually identify cacheable and noncacheable data types. For example, a business has data (i.e. parts information) stored in a mainframe system that is requested frequently by other systems. The user, via the graphical user interface, instructs the system to inquire if the specific data (i.e. parts information) is eligible to be cached. During runtime, the instructions inform the system to check the cache for the data (i.e. unique part number), If the data exists in the cache, the cached response data is provided directly back to the requesting system. If the data (i.e. unique part number) does not exist in the cache, an orchestrating system will retrieve the data (i.e. unique part number details) from the mainframe system, insert data into the cache for the next request, and provide the response data to the requesting system.

### BRIEF DESCRIPTION OF THE DRAWINGS

FIG. 1 is a block diagram of certain elements of an example network communications system.

FIG. 2 is a block diagram of an example computing device.

FIG. 3 is flowchart of an example process for selectivity caching mainframe data.

FIG. 4 is a screenshot of an example graphical user interface used to manually identify cacheable and noncacheable data types.

### DETAILED DESCRIPTION OF THE PREFERRED EMBODIMENTS

Briefly, methods and apparatus for selectively caching mainframe data are disclosed. In one embodiment, the disclosed process receives user inputs via a graphical user interface (GUI) indicating that certain data types on a first mainframe computer are cacheable. Subsequently, when application programming interface (API) requests are received, data associated with cacheable data types are cached and data associated with noncacheable data types are preferably not cached. When additional API requests are received, cached data is retrieved from the cache and noncached data is retrieved from one or more mainframe computers.

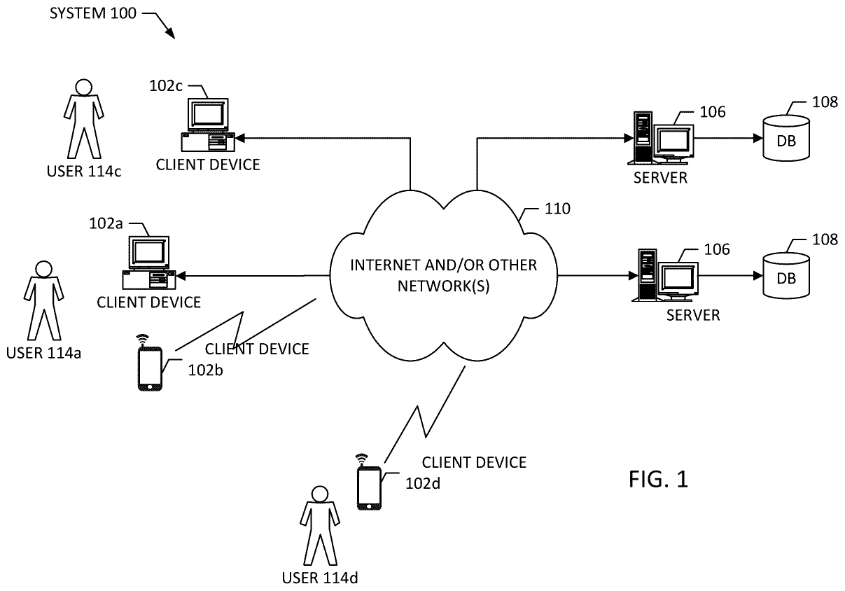

Turning now to the figures, the present system is most readily realized in a network communication system 100. A block diagram of certain elements of an example network communications system 100 is illustrated in FIG. 1. The illustrated system 100 includes one or more client devices 102 (e.g., computer, television, camera, phone, sensor), one or more web servers 106, and one or more databases 108. Each of these devices may communicate with each other via a connection to one or more communications channels 110 such as the Internet and/or some other wired and/or wireless data network, including, but not limited to, any suitable wide area network or local area network. It will be appreciated that any of the devices described herein may be directly connected to each other instead of over a network.

The web server 106 stores a plurality of files, programs, web applications, and/or web pages in one or more databases 108 for use by the client devices 102 as described in detail below. The database 108 may be connected directly to the web server 106 and/or via one or more network connections. The database 108 stores data as described in detail below.

One web server 106 may interact with a large number of client devices 102. Accordingly, each server 106 is typically a high end computer with a large storage capacity, one or more fast microprocessors, and one or more high speed network connections. Conversely, relative to a typical server 106, each client device 102 typically includes less storage capacity, a single microprocessor, and a single network connection.

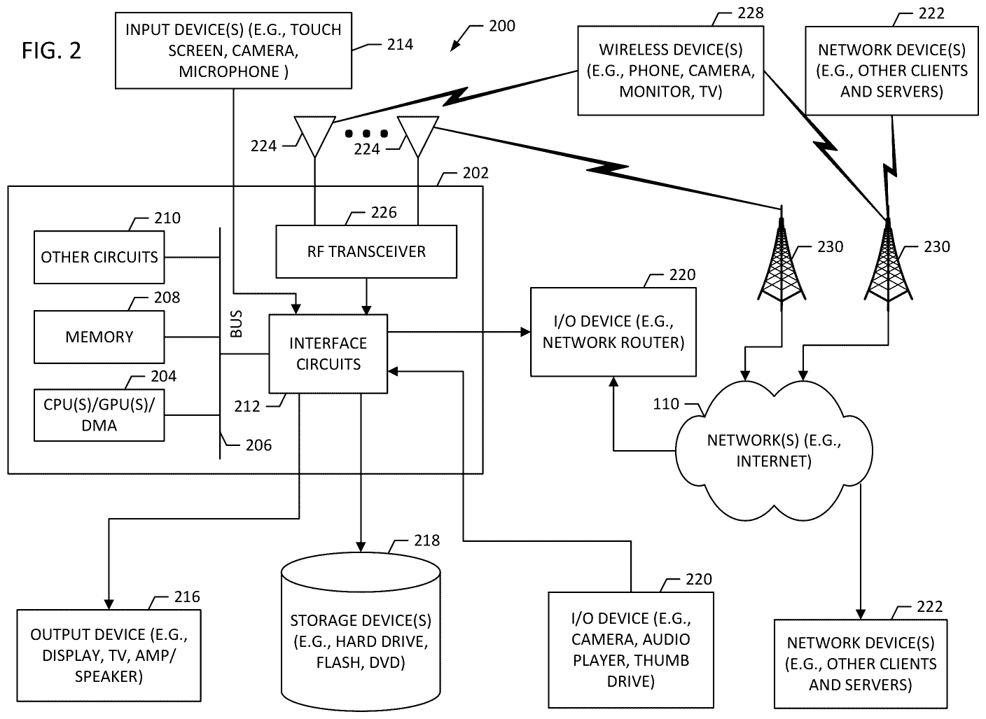

Each of the devices illustrated in FIG. 1 (e.g., clients 102 and/or servers 106) may include certain common aspects of many computing devices such as microprocessors, memories, input devices, output devices, etc. FIG. 2 is a block diagram of an example computing device 200. The example computing device 200 includes a main unit 202 which may include, if desired, one or more processing units 204 electrically coupled by an address/data bus 206 to one or more memories 208, other computer circuitry 210, and one or more interface circuits 212. The processing unit 204 may include any suitable processor or plurality of processors. In addition, the processing unit 204 may include other components that support the one or more processors. For example, the processing unit 204 may include a central processing unit (CPU), a graphics processing unit (GPU), and/or a direct memory access (DMA) unit.

The memory 208 may include various types of non-transitory memory including volatile memory and/or non-volatile memory such as, but not limited to, distributed memory, read-only memory (ROM), random access memory (RAM) etc. The memory 208 typically stores a software program that interacts with the other devices in the system as described herein. This program may be executed by the processing unit 204 in any suitable manner. The memory 208 may also store digital data indicative of documents, files, programs, web pages, etc. retrieved from a server and/or loaded via an input device 214.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a sensor, keyboard, mouse, touch screen, track pad, camera, voice recognition system, accelerometer, global positioning system (GPS), and/or any other suitable input device.

One or more displays, printers, speakers, monitors, televisions, high definition televisions, and/or other suitable output devices 216 may also be connected to the main unit 202 via the interface circuit 212. One or more storage devices 218 may also be connected to the main unit 202 via the interface circuit 212. For example, a hard drive, CD drive, DVD drive, and/or other storage devices may be connected to the main unit 202. The storage devices 218 may store any type of data used by the device 200. The computing device 200 may also exchange data with one or more input/output (I/O) devices 220, such as a sensor, network routers, camera, audio players, thumb drives etc.

The computing device 200 may also exchange data with other network devices 222 via a connection to a network 110. The network connection may be any type of network connection, such as an Ethernet connection, digital subscriber line (DSL), telephone line, coaxial cable, wireless base station 230, etc. Users 114 of the system 100 may be required to register with a server 106. In such an instance, each user 114 may choose a user identifier (e.g., e-mail address), a password, and/or a personal; identification number (PIN), which may be required for the activation of services. The user identifier(s) and password may be passed across the network 110 using encryption built into the user's browser. Alternatively, the user identifier and/or password may be assigned by the server 106.

In some embodiments, the device 200 may be a wireless device 200. In such an instance, the device 200 may include one or more antennas 224 connected to one or more radio frequency (RF) transceivers 226. The transceiver 226 may include one or more receivers and one or more transmitters operating on the same and/or different frequencies. For example, the device 200 may include a sensor, blue tooth transceiver 216, a Wi-Fi transceiver 216, and diversity cellular transceivers 216. The transceiver 226 allows the device 200 to exchange signals, such as voice, video and any other suitable data, with other wireless devices 228, such as a sensor, phone, camera, monitor, television, and/or high definition television. For example, the device 200 may send and receive wireless telephone signals, text messages, audio signals and/or video signals directly and/or via a base station 230.

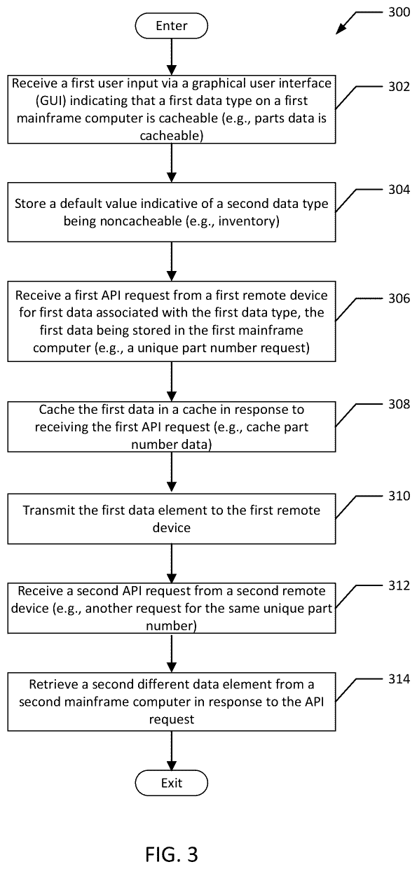

FIG. 3 is a flowchart of an example process 300 for selectively caching mainframe data based on user interface selections designating cacheable and noncacheable data types. The process 300 may be carried out by one or more suitably programmed processors, such as a CPU executing software (e.g., block 204 of FIG. 2). The process 300 may also be carried out by hardware or a combination of hardware and hardware executing software. Suitable hardware may include one or more application specific integrated circuits (ASICs), state machines, field programmable gate arrays (FPGAs), digital signal processors (DSPs), and/or other suitable hardware. Although the process 300 is described with reference to the flowchart illustrated in FIG. 3, it will be appreciated that many other methods of performing the acts associated with process 300 may be used. For example, the order of many of the operations may be changed, and some of the operations described may be optional.

In this example, the process 300 begins by receiving a first user input via a graphical user interface (GUI) indicating that a first data type on a first mainframe computer is cacheable (block 302). For example, the user, via the graphical user interface, may instruct the system that when a client device requests part information (i.e. datatype) that is maintained in a mainframe database it is cacheable for a defined period of time. In addition, the process 300 preferably stores a default value indicative of a second data type being noncacheable (block 304). For example, real time inventory on that part information is not cacheable due to its frequency of change. Subsequently, the process receives a first API request from a first remote device for first data associated with the first data type, the first data being stored in the first mainframe computer (block 306). For example, a unique part number with associated data details.

In response, the process 300 preferably caches the first data in a cache in response to receiving the first API request (block 308). For example, a unique part number with associated data details. The process 300 then preferably transmits the first data element to the first remote device (Block 310).

Later, the process 300 may receive a second API request from a second remote device (block 312). For example, a same unique part number with associated data details as requested in block 306. The process 300 preferably retrieves the requested data element (i.e. part information based on unique part number) from the cache in response to the second API request (Block 314).

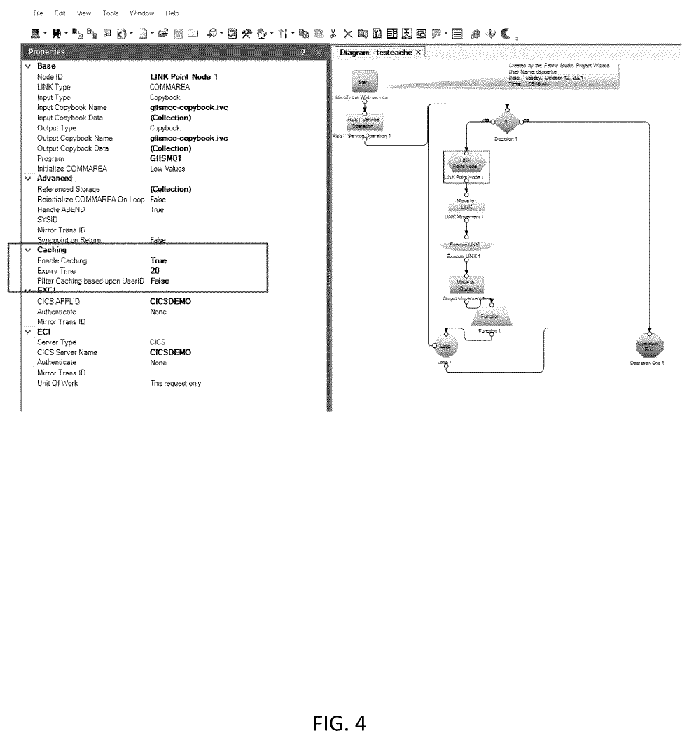

FIG. 4 is a screenshot of an example graphical user interface is used to manually identify cacheable and noncacheable data types. Within a node that defines the type of mainframe data transaction, the user may indicate if the defined data response transaction is to be cached. For data to be cached, the user may inform the system by setting an “Enabling Caching” field to “True”. When Enabling Caching, the user may also define an Expiry Time, which defines how long the data transaction will live in the cache. The user may also inform the system if the cached data transaction is visible only to the selected requester or visible for all to access.

In summary, persons of ordinary skill in the art will readily appreciate that methods and apparatus for selectively caching mainframe data based on user interface selections designating cacheable and noncacheable data types have been provided. The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description of examples, but rather by the claims appended hereto.

What is claimed is:

1. A method of responding to a plurality of application programing interface (API) requests, the method comprising:
receiving a first user input via a graphical user interface (GUI) indicating that a first data type on a first mainframe computer is cacheable;
storing a default value indicative of a second data type being noncacheable;
receiving a first API request from a first remote device for first data associated with the first data type, the first data being stored in the first mainframe computer;
caching the first data in a cache in response to receiving the first API request;
receiving a second API request from a second remote device;
retrieving a first data element from the cache in response to the API request;
retrieving a second different data element from a second mainframe computer in response to the API request; and
transmitting the first data element and the second data element to the second remote device.

2. The method of claim 1, further comprising:
receiving a second user input indicating that a third data type on the first mainframe computer is preemptively cacheable;
receiving a third user input indicating a time period to refresh second data associated with the third data type; and
preemptively caching the second data in the cache in accordance with the time period.

3. The method of claim 1, further comprising:
receiving a second user input indicating that a third data type on the first mainframe computer is preemptively cacheable;
receiving a third user input indicating a time to refresh second data associated with the third data type;
receiving a fourth user input indicating a frequency to refresh the second data associated with the third data type; and
preemptively caching the second data in the cache in accordance with the time and the frequency.

4. The method of claim 1, further comprising periodically running a script to preemptively cache a plurality of data elements.

5. The method of claim 1, wherein no software coding is required.

6. The method of claim 1, wherein no substantive software coding is required.

7. The method of claim 1, further comprising:
receiving a third API request for a third data element;
determining that the third data element is deemed noncacheable; and
retrieving the third data element from the first mainframe computer in response to the third API request and the determination that the third data element is deemed noncacheable.

8. The method of claim 1, wherein the first remote device is the second remote device.

9. The method of claim 1, wherein the first mainframe computer is the second mainframe computer.

10. A method of responding to a plurality of application programing interface (API) requests, the method comprising:
storing a default value indicative of a first data type being cacheable;
receiving a first user input via a graphical user interface (GUI) indicating that a second data type on a first mainframe computer is noncacheable;
receiving a first API request from a first remote device for first data associated with the first data type, the first data being stored in the first mainframe computer;
caching the first data in a cache in response to receiving the first API request;
receiving a second API request from a second remote device;
retrieving a first data element from the cache in response to the API request;
retrieving a second different data element from a second mainframe computer in response to the API request; and
transmitting the first data element and the second data element to the second remote device.

11. An apparatus for responding to a plurality of application programing interface (API) requests, the apparatus comprising:
a processor;
a network communications device operatively coupled to the processor;
a memory operatively coupled to the processor, the memory storing instructions to cause the processor to:
receive a first user input via a graphical user interface (GUI) indicating that a first data type on a first mainframe computer is cacheable;
store a default value indicative of a second data type being noncacheable;
receive a first API request from a first remote device for first data associated with the first data type, the first data being stored in the first mainframe computer;
cache the first data in a cache in response to receiving the first API request;
receive a second API request from a second remote device;
retrieve a first data element from the cache in response to the API request;
retrieve a second different data element from a second mainframe computer in response to the API request; and
transmit the first data element and the second data element to the second remote device.

12. The apparatus of claim 11, wherein the instructions cause the processor to:
receive a second user input indicating that a third data type on the first mainframe computer is preemptively cacheable;
receive a third user input indicating a time period to refresh second data associated with the third data type; and
preemptively cache the second data in the cache in accordance with the time period.

13. The apparatus of claim 11, wherein the instructions cause the processor to:
receive a second user input indicating that a third data type on the first mainframe computer is preemptively cacheable;
receive a third user input indicating a time to refresh second data associated with the third data type;
receive a fourth user input indicating a frequency to refresh the second data associated with the third data type; and
preemptively cache the second data in the cache in accordance with the time and the frequency.

14. The apparatus of claim 11, wherein the instructions cause the processor to periodically run a script to preemptively cache a plurality of data elements.

15. The apparatus of claim 11, wherein the instructions cause the processor to:
receive a third API request for a third data element;
determine that the third data element is deemed noncacheable; and
retrieve the third data element from the first mainframe computer in response to the third API request and the determination that the third data element is deemed noncacheable.

16. A non-transitory memory device storing instructions for responding to a plurality of application programing interface (API) requests, the memory device comprising:
instructions structured to cause a processor to:
receive a first user input via a graphical user interface (GUI) indicating that a first data type on a first mainframe computer is cacheable;
store a default value indicative of a second data type being noncacheable;
receive a first API request from a first remote device for first data associated with the first data type, the first data being stored in the first mainframe computer;
cache the first data in a cache in response to receiving the first API request;
receive a second API request from a second remote device;
retrieve a first data element from the cache in response to the API request;
retrieve a second different data element from a second mainframe computer in response to the API request; and
transmit the first data element and the second data element to the second remote device.

17. The non-transitory memory device of claim 16, wherein the instructions cause the processor to:
receive a second user input indicating that a third data type on the first mainframe computer is preemptively cacheable;
receive a third user input indicating a time period to refresh second data associated with the third data type; and
preemptively cache the second data in the cache in accordance with the time period.

18. The non-transitory memory device of claim 16, wherein the instructions cause the processor to:
receive a second user input indicating that a third data type on the first mainframe computer is preemptively cacheable;
receive a third user input indicating a time to refresh second data associated with the third data type;
receive a fourth user input indicating a frequency to refresh the second data associated with the third data type; and
preemptively cache the second data in the cache in accordance with the time and the frequency.

19. The non-transitory memory device of claim 16, wherein the instructions cause the processor to periodically run a script to preemptively cache a plurality of data elements.

20. The non-transitory memory device of claim 16, wherein the instructions cause the processor to:
receive a third API request for a third data element;
determine that the third data element is deemed noncacheable; and
retrieve the third data element from the first mainframe computer in response to the third API request and the determination that the third data element is deemed noncacheable.
